(19) United States
(12) Patent Application Publication
(10) Pub. No.: US 2026/0116130 A1
(43) Pub. Date: Apr. 30, 2026

(54) Wheel Rim Clamping Device

(71) Applicants: YU-WEN LIN, Chiayi County (TW); Tire Service International LLC, Phoenix, AZ (US)

(72) Inventor: YU-WEN LIN, Chiayi County (TW)

(21) Appl. No.: 18/925,133

(22) Filed: Oct. 24, 2024

(51) Int. Cl. B60C 25/01

(52) U.S. Cl. CPC B60C 25/01

(57) ABSTRACT

A wheel rim clamping device, which has a base, three clamping jaws, a linkage mechanism, and a drive mechanism. The base has a vertical tube and three guide rods arranged horizontally and radiating at equal angles from the vertical tube. Each of the clamping jaws is slidably and correspondingly mounted on one of the guide rods. The linkage mechanism has a triangular plate rotatable around the vertical tube and three curved rods, respectively, provided corresponding with the clamping jaws, wherein one end of each curved rod is pivotally connected with the corresponding clamping jaw and the other end of each curved rod is pivotally connected with the triangular plate. The drive mechanism has a nut fixed on one of the clamping jaws and a screw rod provided on one of the guide rods and screwed to the nut.

### BACKGROUND OF THE PRESENT INVENTION

### Field of Invention

The present invention relates to a wheel rim clamping device, in particular to, a clamping device that uses a screw rod to rotate and uses the curved rods and a triangular plate to simultaneously link three clamping jaws to synchronously clamp the wheel rim.

### Description of Related Arts

The structure of an automobile tire includes a wheel rim and an outer tire. When wanting to replace the outer tire, the wheel rim must be fixed with a machine before the outer tire can be replaced. Therefore, there are many related technologies regarding wheel rim positioning, such as R.O.C. Patent Application Nos. 093221447, 106204654, 102204052, 107145538, and 87213282, taking application No. 87213282 “Quick disassembling structure for tire” as an example, which utilizes the linkage of the guide screw and the bevel gear to achieve the purpose of clamping the outer tire. Nonetheless, despite the efficacy of linking three sets of guide screws with bevel gears in synchronizing clamping jaws to clamp tire, the technology's relatively intricate overall structure renders an assembly inconvenient and the manufacturing costs comparatively high. In order to solve the above-mentioned deficiencies, the present invention develops a wheel rim clamping mechanism with a relatively simple structure.

### SUMMARY OF THE PRESENT INVENTION

Therefore, the purpose of the present invention is to provide a wheel rim clamping device with a relatively simple structure.

Therefore, the wheel rim clamping device of the present invention is used to clamp the wheel rim, and has a base, three clamping jaws, a linkage mechanism and a drive mechanism. The base has a bottom plate, a vertical tube extending upward from a center of the bottom plate, and three guide rods arranged horizontally and radiating at equal angles from the vertical tube. Each of the clamping jaws is slidably and correspondingly mounted on one of the guide rods, wherein the wheel rim is allowed to be placed between the clamping jaws. The linkage mechanism has a triangular plate rotatable around the vertical tube and three curved rods, respectively, provided corresponding with the clamping jaws, wherein one end of each curved rod is pivotally connected with the corresponding clamping jaw and the other end of each curved rod is pivotally connected with the triangular plate. The drive mechanism has a nut fixed on one of the clamping jaws and a screw rod provided on one of the guide rods and screwed to the nut. When the wheel rim is placed on the clamping device and the screw rod is rotated to drive the nut and the clamping jaws, the clamping jaws are simultaneously slid relatively close to each other on the guide rods through the linkage between the curved rods and the triangular plate, thereby clamping the wheel rim. However, the aforementioned structure of the triangular plate and the curved rods simplifies the overall structure of the wheel rim clamping device, which not only facilitates the assembly but also reduces the manufacturing cost.

### BRIEF DESCRIPTION OF THE DRAWINGS

FIG. 1 is a perspective view of a wheel rim clamping device according to a preferred embodiment of the present invention.

FIG. 2 is an exploded view of the wheel rim clamping device according to the preferred embodiment of the present invention.

FIG. 3 is a perspective view of the operation of the wheel rim clamping device according to the preferred embodiment of the present invention.

FIG. 4 is a side view of a wheel rim being placed on the wheel rim clamping device according to the preferred embodiment of the present invention.

FIG. 5 is a side view of the wheel rim clamped by the wheel rim clamping device according to the preferred embodiment of the present invention.

### DETAILED DESCRIPTION OF THE PREFERRED EMBODIMENT

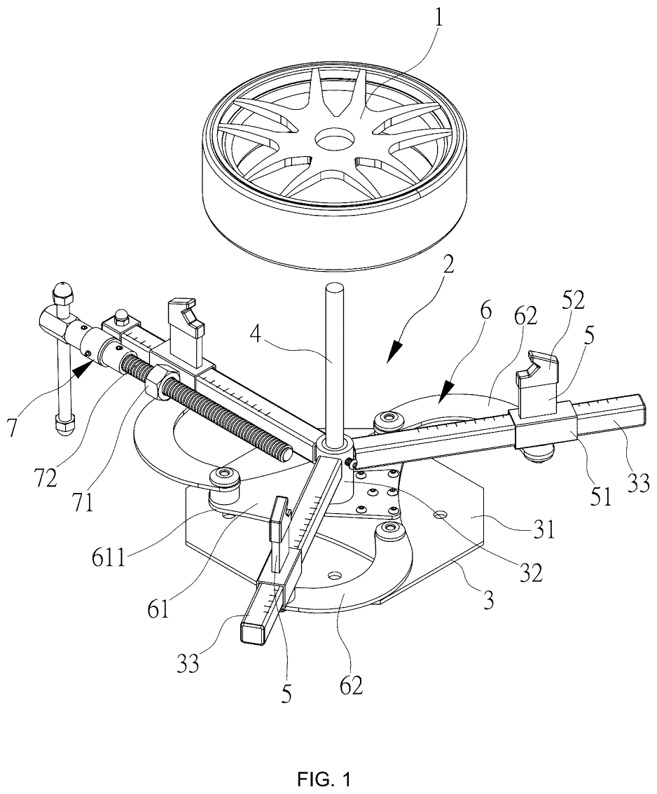

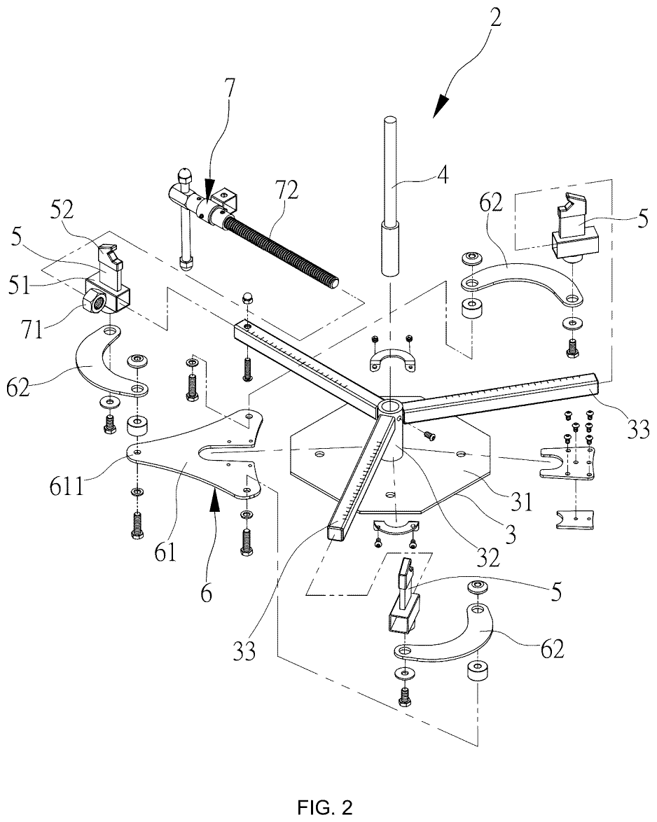

Referring to FIGS. 1 to 2, a preferred embodiment of the present invention is a wheel rim clamping device 2 used to clamp a wheel rim 1, and having a base 3, an upright guide bar 4, three clamping jaws 5, a linkage mechanism 6, and a drive mechanism 7. The base 3 has a bottom plate 31, a vertical tube 32 extending upward from a center of the bottom plate 31, and three guide rods 33 arranged horizontally and radiating at equal angles from the vertical tube 32. The upright guide bar 4 is fixed in the vertical tube 32 and protrudes upward, and is used to guide the placement of the wheel rim 1. Each clamping jaw 5 has a sliding portion 51 which is correspondingly slidably mounted on one of the guide rods 33, and a clamping portion 52 which extends upwardly from the sliding portion 51. The wheel rim 1 is allowed to be placed between the clamping portions 52 with the guidance of the upright guide bar 4. The linkage mechanism 6 has a triangular plate 61 rotatable around the vertical tube 32 and three curved rods 62 respectively corresponding to the clamping jaws 5. The triangular plate 61 has three pivot portions 611, respectively, located at three corners of the triangle thereof. One end of each curved rod 62 is pivotally connected with the sliding portion 51 of the corresponding clamping jaw 5, and the other end of each curved rod 62 is pivotally connected with the corresponding pivot portion 611 of the triangular plate 61. When the triangular plate 61 pivots relative to the vertical tube 32, the curved rods 62 move synchronously and at the same angle. The driving mechanism 7 has a nut 71 fixed on the side of the sliding portion 51 of one of the clamping jaws 5, and a screw rod 72, which is pivoted on the side of one of the guide rods 33 and is screwed to the nut 71.

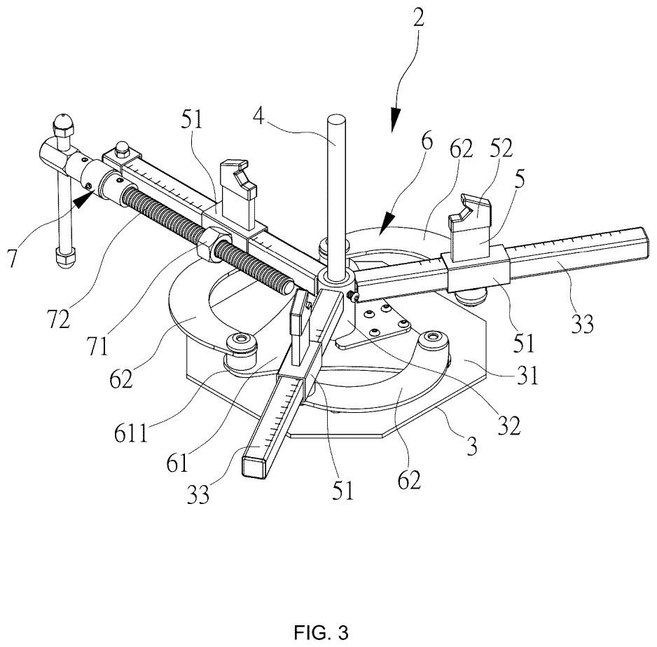

The wheel rim clamping device 2 of the present invention only needs to rotate the screw rod 72 of the drive mechanism 7 in operation, the screw rod 72 rotates in situ and drives the nut 71 to move on the screw rod 72, the sliding portion 51 of the clamping jaw 5 connected with the nut 71 also slides on the guide rod 33 at this moment. The sliding portion 51 connected with the nut 71 simultaneously drives the triangular plate 61 to pivot relative to the vertical tube 32 through the curved rod 62, and the other two curved rods 62 are simultaneously driven by the triangular plate 61 to link the remaining two clamping jaws 5. As shown in FIG. 3, the clamping jaws 5 driven by the screw rod 72 are close to each other. Similarly, as long as the screw rod 72 is rotated in the opposite direction, the clamping jaws 5 will move away from each other in the opposite direction.

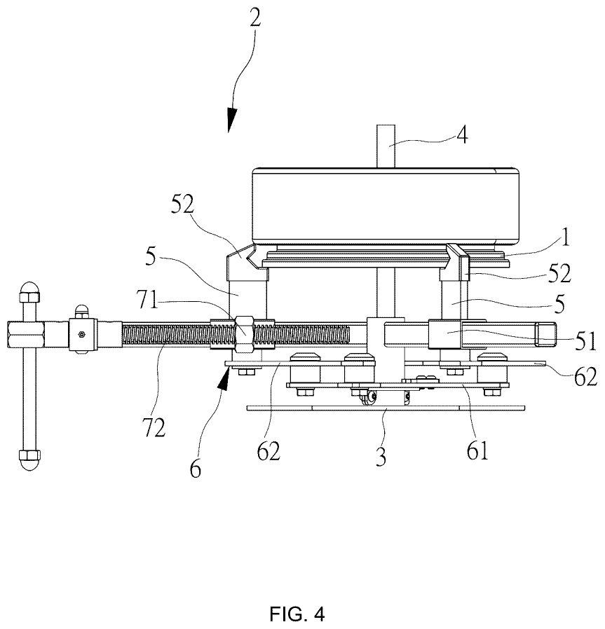

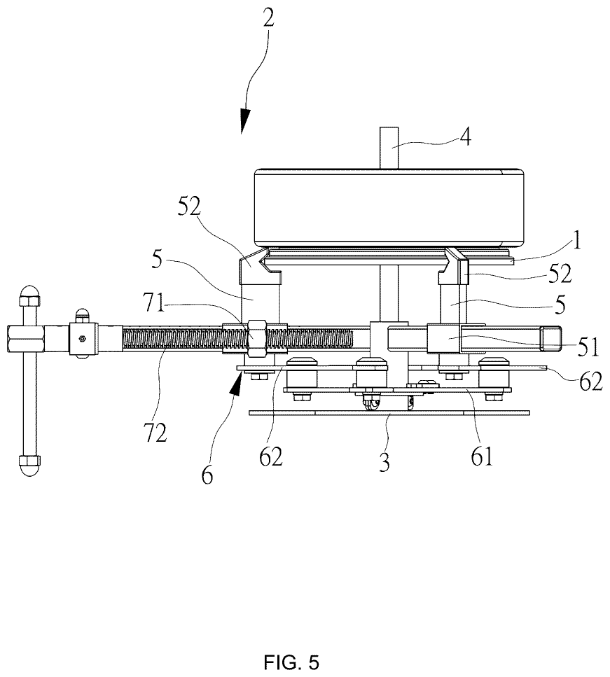

When the wheel rim 1 is to be clamped, the wheel rim 1 with an outer tire is guided and placed on the clamping portions 52 of the clamping jaws 5 by the upright guide bar 4 as shown in FIG. 4, then the screw rod 72 is rotated, and the clamping jaws 5 are brought close to each other by the linkage of the curved rods 62 and the triangular plate 61 of the linkage mechanism 6, and finally the wheel rim 1 is clamped as shown in FIG. 5.

The wheel rim clamping device 2 of the present invention uses the screw rod 72 and the nut 71 of the rotation mechanism to drive the clamping jaws 5 to clamp the wheel rim 1. The curved rods 62 can move synchronously through the arrangement of the triangular plate 61, so that the clamping jaws 5 can be relatively close or far away, respectively, to achieve the purpose of clamping the wheel rim 1 or releasing the wheel rim 1. Moreover, the aforementioned structures of the triangular plate 61 and the curved rods 62 simplify the overall structure of the wheel rim clamping device 2, which not only makes assembly more convenient, but also reduces manufacturing costs.

What is claimed is:

1. A wheel rim clamping device for clamping a wheel rim, comprising:
a base having a bottom plate, a vertical tube extending upward from a center of the bottom plate, and three guide rods arranged horizontally and radiating at equal angles from the vertical tube;
three clamping jaws, each of which is slidably and correspondingly mounted on one of the guide rods, wherein the wheel rim is allowed to be placed between the clamping jaws;
a linkage mechanism having a triangular plate rotatable around the vertical tube and three curved rods, respectively, provided corresponding with the clamping jaws, wherein one end of each curved rod is pivotally connected with the corresponding clamping jaw and the other end of each curved rod is pivotally connected with the triangular plate; and
a drive mechanism having a nut fixed on one of the clamping jaws and a screw rod provided on one of the guide rods and screwed to the nut;
wherein when the wheel rim is placed on the clamping device and the screw rod is rotated to drive the nut and the clamping jaws, the clamping jaws are simultaneously slid relatively close to each other on the guide rods through the linkage between the curved rods and the triangular plate, thereby clamping the wheel rim.

2. The wheel rim clamping device, as recited in claim 1, wherein the clamping device further has an upright guide bar fixed in the vertical tube and protruding upward, which is used to guide the wheel rim to be placed between the clamping jaws.
